(19) United States
(12) Patent Application Publication
(10) Pub. No.: US 2022/0288826 A1
(43) Pub. Date: Sep. 15, 2022

(54) MANUFACTURING APPARATUS AND MANUFACTURING METHOD FOR MOLDED PRODUCT OF FIBER-REINFORCED RESIN

(71) Applicant: HONDA MOTOR CO., LTD., Tokyo (JP)

(72) Inventors: Masatoshi Kobayashi, Wako-shi (JP); Kazuhiro Mori, Wako-shi (JP); Mitsuharu Kan, Wako-shi (JP); Satoshi Ozaki, Wako-shi (JP)

(21) Appl. No.: 17/680,524

(22) Filed: Feb. 25, 2022

(30) Foreign Application Priority Data
Mar. 11, 2021 (JP) 2021-038962

(51) Int. Cl. B29C 45/18; B29B 7/90; B29C 45/00; B29C 45/47

(52) U.S. Cl. CPC B29C 45/1866; B29B 7/90; B29C 45/0005; B29C 45/47; B29K 2309/08

(57) ABSTRACT

A manufacturing apparatus for a molded product of a fiber-reinforced resin includes: a heating tube; a screw inserted in the heating tube; an injector provided on a front end side of the screw; a resin feeder configured to feed a matrix resin into the heating tube; a long-fiber feeder configured to feed a long fiber into the heating tube; and a short-fiber feeder configured to feed a short fiber shorter than the long fiber into the heating tube. The short-fiber feeder is closer to a rear end of the screw than the long-fiber feeder is.

### CROSS-REFERENCE TO RELATED APPLICATIONS

This application is based upon and claims the benefit of priority from Japanese Patent Application No. 2021-038962 filed on Mar. 11, 2021; the entire contents of which are incorporated herein by reference.

### BACKGROUND

The present disclosure relates to a manufacturing apparatus and a manufacturing method for a molded product of a fiber-reinforced resin.

As a manufacturing apparatus for a molded product of a fiber-reinforced resin, there is known an apparatus that includes a feed port for a mold material on the base end (rear end) side of a heating tube and that includes an injector on the front end side of the heating tube, the heating tube having an interior in which a screw is inserted, the injector configured to inject the molten mold material into a predetermined mold (for example, see JP2019-030977A). In this manufacturing apparatus, a fiber and a resin are independently fed into feed ports unlike an apparatus that uses, for example, a resin pellet containing a fiber in advance as the mold material.

According to such a manufacturing apparatus, it is possible to obtain a resin molded product containing a longer fiber than a resin molded product obtained from the resin pellet containing the fiber in advance. The resin molded product containing the long fiber as described above has higher stiffness and higher strength than a resin molded product containing a short fiber.

However, in the aforementioned manufacturing apparatus for a molded product of a fiber-reinforced resin (for example, see JP2019-30977A), the fiber fed to the feed port on the upstream side tends to break and become shorter in kneading with the resin by the screw before reaching the injector on the downstream side.

Accordingly, setting a feed port for the fiber downstream of a feed port for the resin is conceivable to reduce breaking of the fiber in the kneading.

However, when the feed port for the fiber is set in a downstream portion of the heating tube, the fiber is uniformly dispersed in the resin and the stiffness and strength of the obtained resin molded product rather decrease.

### SUMMARY

A manufacturing apparatus for a molded product of a fiber-reinforced resin includes: a heating tube; a screw which is inserted in the heating tube; an injector which is provided on a front end side of the screw; a resin feeder which is configured to feed a matrix resin into the heating tube; a long-fiber feeder which is configured to feed a long fiber into the heating tube; and a short-fiber feeder which is configured to feed a short fiber shorter than the long fiber into the heating tube. The short-fiber feeder is closer to a rear end of the screw than the long-fiber feeder is.

Moreover, a manufacturing method for a molded product of a fiber-reinforced resin that solves the aforementioned problems is a manufacturing method for a molded product of a fiber-reinforced resin including: forming a mold material by feeding a matrix resin, a long fiber, and a short fiber shorter than the long fiber into a heating tube including a screw therein; and injecting the mold material from the heating tube into a mold. The long fiber is fed into the heating downstream of positions at which the matrix resin and the short fiber are fed respectively.

### BRIEF DESCRIPTION OF THE ACCOMPANYING DRAWINGS

FIG. 1 is a configuration explanation diagram of a manufacturing apparatus for a molded product of a fiber-reinforced resin according to an embodiment of the present disclosure.

FIG. 2A is an enlarged diagram of a main portion of a manufacturing apparatus for a molded product of a fiber-reinforced resin according to a first modified example of the present disclosure.

FIG. 2B is a plan diagram of a lid illustrated in FIG. 2A.

FIG. 3A is an enlarged diagram of a main portion of a manufacturing apparatus for a molded product of a fiber-reinforced resin according to a second modified example of the present disclosure.

FIG. 3B is a cross-sectional diagram along the line IIIb-IIIb in FIG. 3A.

FIG. 4 is an enlarged diagram of a main portion of a manufacturing apparatus for a molded product of a fiber-reinforced resin according to a third modified example of the present disclosure.

FIG. 5 is an enlarged diagram of a main portion of a manufacturing apparatus for a molded product of a fiber-reinforced resin according to a fourth modified example of the present disclosure.

### DESCRIPTION OF EMBODIMENTS

Next, a manufacturing apparatus and a manufacturing method for a molded product of a fiber-reinforced resin in a mode (embodiment) for carrying out the present disclosure are described in detail.

The manufacturing apparatus for the molded product of the fiber-reinforced resin (hereinafter, simply referred to as resin molded product manufacturing apparatus in some cases) of the embodiment includes a short-fiber feeder and a long-fiber feeder in a heating tube, and has such a main characteristics that the short-fiber feeder is closer to a rear end of a screw than the long-fiber feeder is. Although the present disclosure is specifically described below by using a single-screw resin molded product manufacturing apparatus as an example, the present disclosure can be also applied to a twin-screw resin molded product manufacturing apparatus.

### <Resin Molded Product Manufacturing Apparatus>

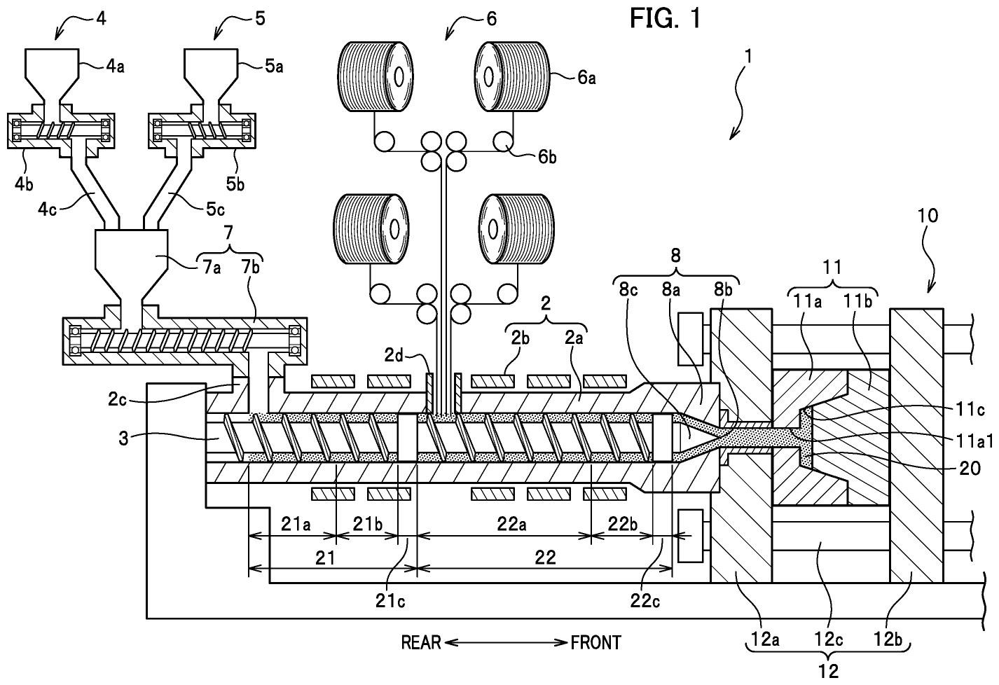

FIG. 1 is a configuration explanation diagram of a resin molded product manufacturing apparatus 1 according to the embodiment. Note that a front-rear direction in the following description is based on a front-rear direction illustrated by the arrow in FIG. 1 in which the downstream side in a direction of conveyance of a mold material by a screw to be described later is the front side and the upstream side is the rear side.

As illustrated in FIG. 1, the resin molded product manufacturing apparatus 1 includes a heating tube 2, a screw 3, a resin feeder 4, a short-fiber feeder 5, a long-fiber feeder 6, an injector 8, and a mold mechanism 10.

The heating tube 2 includes a cylindrical cylinder 2a and multiple band heaters 2b arranged on an outer periphery of the cylinder 2a.

Moreover, the heating tube 2 includes a feed port 2c from which a matrix resin and the short fiber are fed and a feed port 2d from which the long fiber to be described later is fed as described in detail later.

The screw 3 is rotated about an axis by a not-illustrated screw drive mechanism to convey a mold material to be described later forward in the cylinder 2a and advances and retreats in an axial direction in synchronization with a predetermined timing at which the mold material is injected from the injector 8.

The screw 3 includes a first stage 21 formed of a first supply portion 21a, a first compression portion 21b, and a first measurement portion 21c and a second stage 22 subsequent to and downstream of the first stage 21 and formed of a second supply portion 22a, a second compression portion 22b, and a second measurement portion 22c which are arranged in this order from the upstream side to the downstream side.

Note that the screw 3 illustrated in FIG. 1 is schematically illustrated for the convenience of illustration and has a different shape from the actual screw 3.

The first supply portion 21a supplies (feeds) a first mold material including the matrix resin and the short fiber to be described later forward in the heating tube 2. Note that the first mold material is heated in the first supply portion 21a to cause a thermoplastic resin contained in the first mold material to melt and is thus plasticized.

The first compression portion 21b compresses the first mold material between itself and the heating tube 2 by conveying the first mold material forward.

The first measurement portion 21c applies shear force to the first mold material between itself and the heating tube 2 while sending a predetermined amount of the first mold material forward in synchronization with rotation and an advancing and retreating operation of the screw 3.

The first mold material passes the first compression portion 21b and the first measurement portion 21c while being kneaded and heated by the band heaters 2b. This, together with shear heat in the first measurement portion 21c, causes the first mold material to become a flowable resin composition in which the short fiber is uniformly dispersed in the matrix resin.

The second supply portion 22a supplies (feeds) a second mold material, obtained by adding the long fiber to be described later to the first mold material conveyed from the first stage 21, further forward in the heating tube 2.

The second compression portion 22b compresses the second mold material between itself and the heating tube 2 by conveying the second mold material forward.

The second measurement portion 22c measures a predetermined amount of the second mold material to be injected in synchronization with the rotation and the advancing and retreating operation of the screw 3.

The resin feeder 4 includes a hopper 4a, a feed screw 4b, and a chute 4c.

The short-fiber feeder 5 includes a hopper 5a, a feed screw 5b, and a chute 5c.

The resin feeder 4 and the short-fiber feeder 5 in the embodiment have the common feed port 2c for the heating tube 2.

Specifically, the chute 4c of the resin feeder 4 and the chute 5c of the short-fiber feeder 5 communicate with the common feed port 2c via a mixer 7 for the matrix resin and the short fiber constituting the first mold material.

The mixer 7 in the embodiment includes a merge tank 7a to which both of the chute 4c and the chute 5c are connected and a screw mixer 7b that is arranged between the merge tank 7a and the feed port 2c and that mixes the matrix resin and the short fiber from the merge tank 7a. However, the mixer 7 is not limited to this configuration and may have any configuration as long as it is capable of mixing the matrix resin and the short fiber. For example, the mixer 7 may have a configuration in which an agitation blade is arranged in the merge tank 7a.

The long-fiber feeder 6 in the embodiment is assumed to be a feeder that feeds the long fiber in a form of rovings into the feed port 2d. Specifically, the long-fiber feeder 6 includes fiber rolls 6a around which unbroken fibers are wound and guide rollers 6b that guide the rovings lead out from the fiber rolls 6a toward the feed port 2d.

The long-fiber feeder 6 has a configuration in which the rovings are directly fed into the cylinder 2a through the feed port 2d.

The long fiber in the embodiment refers to a fiber that has an average fiber length larger than the average fiber length of the short fiber fed from the short-fiber feeder 5 to the cylinder 2a.

Accordingly, the long-fiber feeder 6 in the embodiment is not limited to a feeder that supplies the long fiber in the form of rovings (unbroken fibers) into the cylinder 2a and may be formed of a device such as, for example, a hopper that feeds a long fiber cut into a predetermined length into the feed port 2d.

The injector 8 is formed of a cylinder head 8a inside which a conical front end portion 8c of the screw 3 is housed.

The injector 8 injects the mold material into a mold 11 of the mold mechanism 10 to be described next, through an injection port 8b formed in a front end portion of the cylinder head 8a.

The mold mechanism 10 includes a mold 11 and a mold clamping mechanism 12.

The mold 11 includes a fixed mold 11a and a movable mold 11b. The mold 11 includes a cavity 11c adopting a shape of a resin molded product 20 between the fixed mold 11a and the movable mold lib. The fixed mold 11a has an introduction port 11a1 for the mold material. The aforementioned injector 8 injects the mold material into the cavity 11c through the introduction port 11a1.

The mold clamping mechanism 12 includes a fixed platen 12a to which the fixed mold 11a is attached, a movable platen 12b to which the movable mold 11b is attached, and a tie bar 12c. The tie bar 12c supports the fixed platen 12a in an end portion thereof and supports the movable platen 12b such that the movable platen 12b can be moved toward and away from the fixed platen 12a. Although illustration is omitted, the mold clamping mechanism 12 includes a mold opening-closing unit that performs mold opening and mold closing of the movable mold 11b relative to the fixed mold 11a at predetermined load.

### <Manufacturing Method for Resin Molded Product>

Next, the manufacturing method for the resin molded product 20 (see FIG. 1) according to the embodiment is described while illustrating operations of the resin molded product manufacturing apparatus 1 (see FIG. 1).

In the manufacturing method for the resin molded product 20 according to the embodiment, first, the matrix resin is fed to the hopper 4a of the resin feeder 4 and the short fiber is fed to the hopper 5a of the short-fiber feeder 5.

The matrix resin is the embodiment is assumed to be nylon 6. Moreover, the short fiber is assumed to be glass fiber.

However, the matrix resin is not limited to nylon 6 and it is possible to use, for example: a thermoplastic resin such as polypropylene, polyethylene, nylon 66, polystyrene, an acryl resin, acrylonitrile-butadiene, polycarbonate, an acrylonitrile-butadiene-styrene copolymer resin, a polyphenylenesulfide resin, modified-polyphenyleneether, polyester, polysulfone, a liquid crystal polymer, polybutylene terephthalate, or polyacetal; or a biodegradable resin such as a polylactic acid (PLA) based resin, a polyhydroxyalkanoate (PHA) based resin, polybutylene succinate (PBS), polybutylene adipate terephthalate (PBAT), a starch polyester resin, cellulose acetate, polyvinyl alcohol (PVA), polyglycolic acid (PGA), polybutylene succinate adipate (PBSA), or polyethylene terephthalate succinate (PETS). The shape of the matrix resin fed from the resin feeder 4 is not limited to a particular shape and may be, for example, a pellet shape or a particle shape.

Moreover, the short fiber is not limited to the glass fiber and it is possible to use, for example, carbon fiber, basalt fiber, metal fiber, silicon carbide fiber, callouses fiber, aramid fiber, boron fiber, alumina fiber, or the like.

Furthermore, recycled fiber can be used as the short fiber.

The average fiber length of the short fiber in the embodiment is assumed to be equal to or larger than the fiber diameter dimension and smaller than 0.5 mm. Note that the lower limit of the average fiber length is, for example, about 14 μm in the case of the glass fiber and about 7 μm in the case of the carbon fiber.

The matrix resin and the short fiber fed from the resin feeder 4 and the short-fiber feeder 5 are mixed together while passing the mixer 7 and form the first mold material.

Then, the first mold material is fed into the cylinder 2a through the feed port 2c.

The screw 3 in the cylinder 2a conveys the first mold material downstream in the cylinder 2a. The first mold material passes the first stage 21 to become the plasticized resin composition in which the short fiber is uniformly dispersed in the matrix resin as described above.

Next, in this manufacturing method, the long fiber is added to the first mold material having passed the first stage.

Specifically, the long fiber is directly fed from the long-fiber feeder 6 into the cylinder 2a through the feed port 2d in the form of rovings as described above.

The same type of fiber as the short fiber may be used as the long fiber. However, a type of fiber different from the short fiber may be selected as the long fiber. For example, the configuration may be such that the glass fiber is used as the short fiber and the carbon fiber is used as the long fiber.

When the long fiber cut in advance is to be used, the average fiber length is preferably 0.5 mm or more and 30 mm or less.

Moreover, the second mold material obtained by adding the long fiber to the first mold material passes the second stage 22 to become the injection mold material in which the long fiber is dispersed in the first mold material as described above.

Next, in this manufacturing method, the mold material in which the short fiber and the long fiber are dispersed in the matrix resin is injected into the mold 11 of the mold mechanism 10 through the injector 8. Then, the mold opening and mold closing at the predetermined load are performed in the mold mechanism 10 and the target resin molded product 20 is obtained.

As described above, the manufacturing method for the resin molded product 20 (see FIG. 1) performed by using the resin molded product manufacturing apparatus 1 (see FIG. 1) is a direct injection molding method in which the mold material formed by directly feeding the matrix resin, the short fiber, and the long fiber into the heating tube 2 including the screw is injected into the mold 11 to obtain the resin molded product 20. This manufacturing method has such a main characteristic that the feeding of the long fiber in the heating tube 2 is performed downstream of the feeding position of the short fiber as described above.

Note that conditions of the operation of the resin molded product manufacturing apparatus 1 in the embodiment are condition examples in the case where a resin molded product containing a glass fiber in nylon 6 is to be manufactured. However, the conditions may be set as appropriate depending on the matrix resin and the fibers to be used.
(1) Cylinder temperature on screw upstream side: around room temperature
(2) Cylinder temperature on screw downstream side: 320° C. or lower
(3) Screw backpressure: 0.1 to 10 MPa
(4) Number of revolutions of screw: 420 min⁻¹ or lower
(5) Injection rate: 1300 mm/sec or lower
(6) Injection pressure: 350 MPa or lower
(7) Mold temperature: 40 to 180° C.
(8) Holding pressure: 150 MPa or less
(9) Cooling time: 30 to 100 sec

### <Operations and Effects>

Next, description is given of operations and effects of the resin molded product manufacturing apparatus 1 and the manufacturing method for the resin molded product according to the embodiment.

In the resin molded product manufacturing apparatus 1 according to embodiment, the short-fiber feeder 5 is closer to the rear end of the screw 3 than the long-fiber feeder 6 is. In other words, the feeding of the long fiber into the heating tube 2 is performed downstream of the feeding positions of the matrix resin and the short fiber, respectively.

In the resin molded product manufacturing apparatus 1 as described above, the short fiber is mixed with the matrix resin from the rear end side of the screw 3 for a long period and the homogeneity (dispersity of the short fiber) is thus improved.

Meanwhile, since the long fiber is injected in a shorter period than the short fiber, crushing (length reduction) of the long fiber is reduced. This improves an abundance ratio of the long fiber in the resin molded product.

The obtained resin molded product 20 thus has high stiffness, high strength, high impact strength, and few sinks which are characteristics provided by the long fiber and also has excellent exterior and excellent fatigue strength which are characteristics provided by the short fiber.

Moreover, in the resin molded product manufacturing apparatus 1, the resin feeder 4 and the short-fiber feeder 5 have the common feed port 2c for the heating tube 2.

In the resin molded product manufacturing apparatus 1 as described above, employing the common feed port 2c reduces a heat dissipation amount from the feed port 2c and energy loss can be reduced to a low level. Moreover, in the resin molded product manufacturing apparatus 1, employing the common feed port 2c promotes mixing of the matrix resin and the short fiber and improves homogeneity of the short fiber in the obtained resin molded product 20.

Moreover, the resin molded product manufacturing apparatus 1 includes the mixer 7 that mixes the matrix resin and the short fiber in advance before feeding into the heating tube 2.

In the resin molded product manufacturing apparatus 1 as described above, the pre-mixing by the mixer 7 improves the uniformity of the short fiber in the obtained resin molded product 20 even if, for example, the matrix resin and the short fiber vary greatly in specific weight or the diameter and length of the short fiber included in a lot to be fed are nonuniform.

Although the embodiment of the present disclosure has been described above, the present disclosure is not limited to the aforementioned embodiment and can be carried out in various modes.

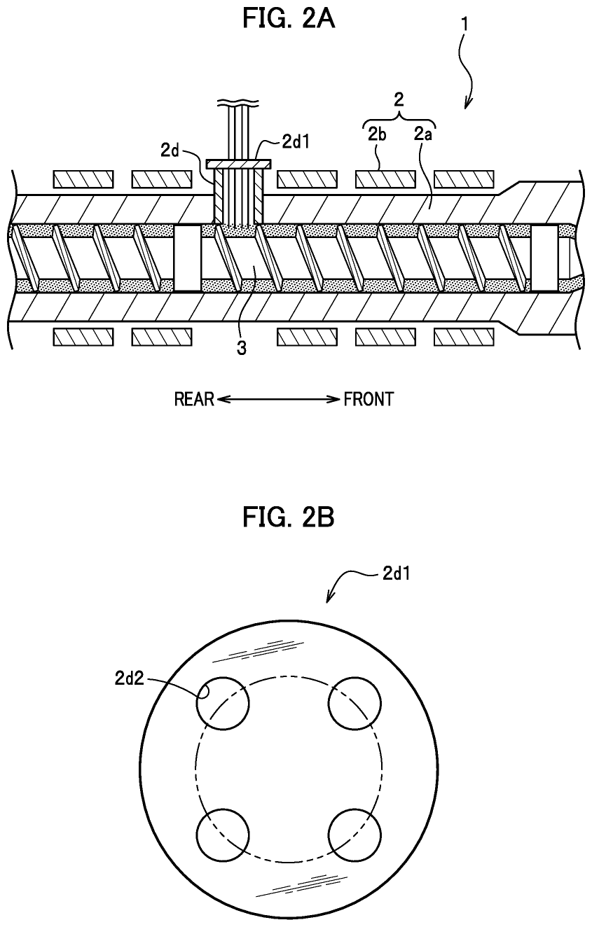

FIG. 2A is an enlarged diagram of a main portion of a resin molded product manufacturing apparatus 1 in a first modified example of the present disclosure. FIG. 2B is a plan diagram of a lid 2d1 illustrated in FIG. 2A. Note that, in FIG. 2A, components similar to those in the resin molded product manufacturing apparatus 1 (see FIG. 1) of the aforementioned embodiment are denoted by the same reference numerals and detailed description thereof is omitted.

As illustrated in FIG. 2A, the resin molded product manufacturing apparatus 1 according to the first modified example includes the lid 2d1 in the feed port 2d, unlike the resin molded product manufacturing apparatus 1 of the aforementioned embodiment.

As illustrated in FIG. 2B, the lid 2d1 is made of a plate body having a circular flat surface shape and has multiple (four in the embodiment) through holes 2d2 corresponding to the number of fiber rolls 6a (see FIG. 1).

The through holes 2d2 are formed to be arranged at even intervals on a line concentric to a peripheral edge of the lid 2d1 in a plan diagram of the lid 2d1.

Generally, factors that cause quality decrease of a molded product made of a fiber-reinforced resin include a remaining fiber bundle. The remaining fiber bundle is, for example, rovings that are supplied to the heating tube 2 while tangling with one another and remain as a bundle of fibers in a resin molded product. The remaining fiber bundle reduces the stiffness, strength, and impact strength of the resin molded product in some cases.

In order to reduce generation of the remaining fiber bundle in the resin molded product, for example, employing a screw 3 designed to have a long kneading section is conceivable. However, when the kneading of the mold material by the screw 3 is excessive, the long fiber breaks and the length thereof is reduced.

Meanwhile, in the resin molded product manufacturing apparatus 1 according to the first modified example, the unbroken fibers (rovings) pass the multiple through holes 2d2 of the lid 2d1, respectively, and are then fed into the heating tube 2 (cylinder 2a). This can prevent the unbroken fibers (rovings) fed into the heating tube 2 (cylinder 2a) from tangling with one another. The generation of the fiber bundle in the mold material is reduced.

The remaining fiber bundle in the obtained resin molded product is thereby reduced and the resin molded product can more surely have excellent stiffness, strength, and impact strength.

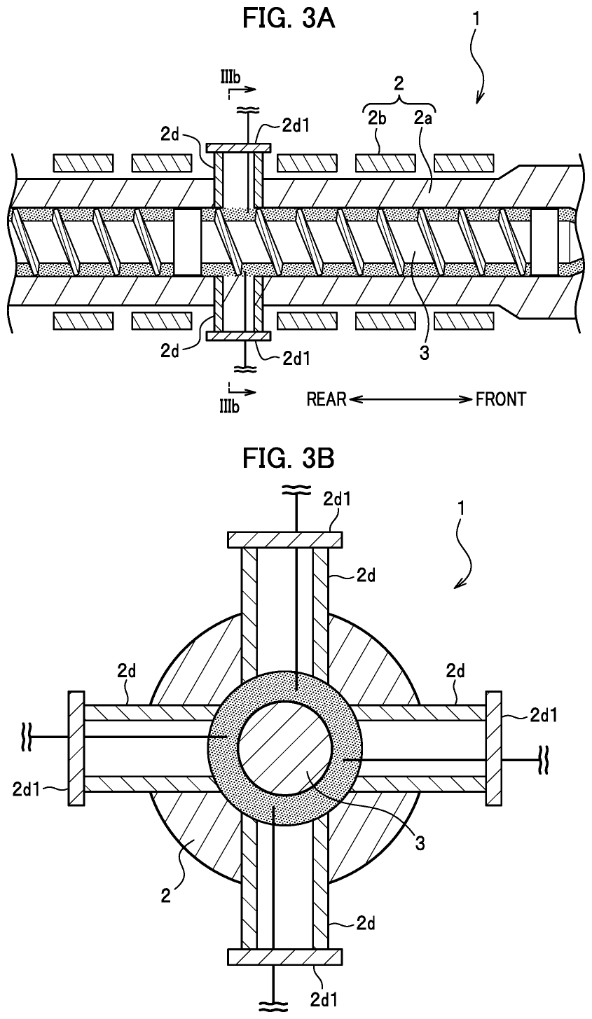

FIG. 3A is an enlarged diagram of a main portion of a resin molded product manufacturing apparatus 1 according to a second modified example. FIG. 3B is a cross-sectional diagram along the line IIIb-IIIb in FIG. 3A. Note that, in FIGS. 3A and 3B, components similar to those in the resin molded product manufacturing apparatus 1 (see FIG. 1) of the aforementioned embodiment and the first modified example (see FIGS. 2A and 2B) are denoted by the same reference numerals and detailed description thereof is omitted.

As illustrated in FIGS. 3A and 3B, in the resin molded product manufacturing apparatus 1 according to the second modified example, multiple feed ports 2d for the long fiber are arranged at equal intervals in the circumferential direction of the heating tube 2.

Note that, in the second modified example illustrated in FIGS. 3A and 3B, four feed ports 2d are arranged at intervals of 90 degrees in the circumferential direction of the heating tube 2.

The resin molded product manufacturing apparatus 1 according to the second modified example as described above more surely reduces the tangling of rovings in the long-fiber feeder 6. The remaining fiber bundle in the obtained resin molded product is thereby more surely reduced and the resin molded product can have even higher stiffness, strength, and impact strength.

Although the feed ports 2d are each assumed to have a lid 2d1 in which one through hole (not illustrated) is formed as illustrated in FIG. 3A in the resin molded product manufacturing apparatus 1 according to the second modified example, the lid 2d1 may be the lid 2d1 having the multiple through holes 2d2 illustrated in FIG. 2B.

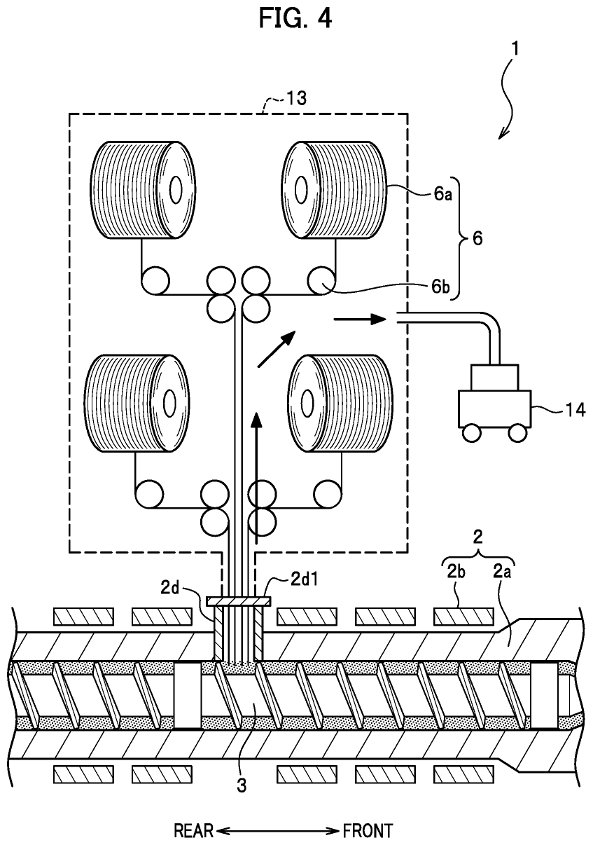

FIG. 4 is an enlarged diagram of a main portion of a resin molded product manufacturing apparatus 1 according to a third modified example. Note that, in FIG. 4, components similar to those in the resin molded product manufacturing apparatus 1 (see FIG. 1) of the aforementioned embodiment, the first modified example (see FIGS. 2A and 2B), and the second modified example (see FIGS. 3A and 3B) are denoted by the same reference numerals and detailed description thereof is omitted.

As illustrated in FIG. 4, in the resin molded product manufacturing apparatus 1 according to the third modified example, the long-fiber feeder 6 is included in a sealed container 13 including a depressurizer 14 (for example, a vacuum pump or the like).

Generally, factors that cause quality decrease of a molded product made of a fiber-reinforced resin include a void formed in the fiber-reinforced resin. This void may be formed by entrapment of an air bubble in the mold material that occurs when the fiber is included in the matrix resin. Such a void may reduce the stiffness, strength, and impact strength of the resin molded product 20.

Meanwhile, in the resin molded product manufacturing apparatus 1 according to the third modified example, the inside of the sealed container 13 is depressurized with the depressurizer and an air bubble is thereby prevented from being entrapped in the mold material in the feeding of the long fiber into the heating tube 2. Moreover, in the resin molded product manufacturing apparatus 1 according to the third modified example, the feed port 2d may be used for ventilation of volatile components generated in the mold material in the first stage 21 (see FIG. 1).

In the resin molded product manufacturing apparatus 1 according to the third modified example as described above, the obtained resin molded product has even higher stiffness, strength, and impact strength.

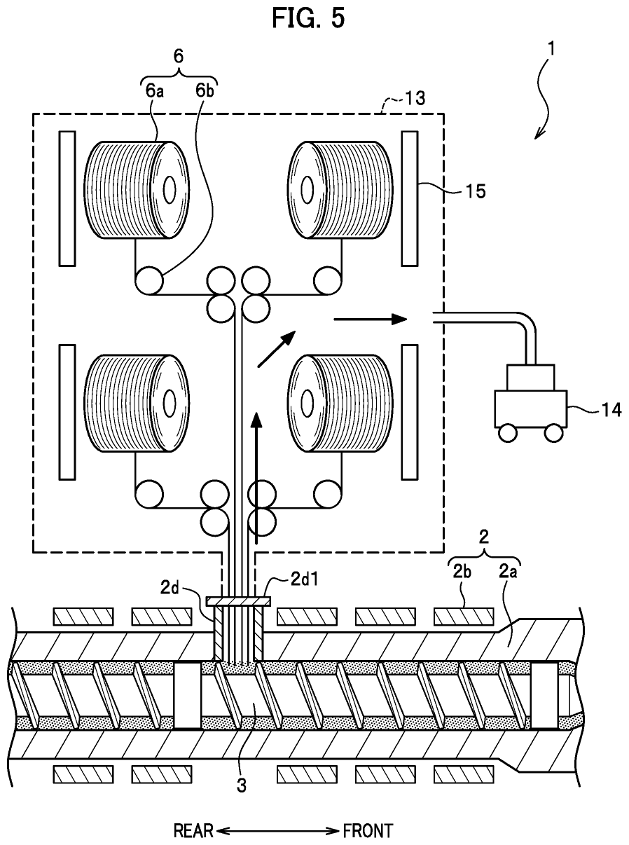

FIG. 5 is an enlarged diagram of a main portion of a resin molded product manufacturing apparatus 1 according to a fourth modified example. In FIG. 5, components similar to those in the resin molded product manufacturing apparatus 1 (see FIG. 1) of the aforementioned embodiment, the first modified example (see FIGS. 2A and 2B), the second modified example (see FIGS. 3A and 3B), and the third modified example (see FIG. 4) are denoted by the same reference numerals and detailed description thereof is omitted.

As illustrated in FIG. 5, the resin molded product manufacturing apparatus 1 according to the fourth modified example includes a heater 15 that heats the long fiber in advance before the feeding into the heating tube 2.

In the resin molded product manufacturing apparatus 1 according to the fourth modified example, the heater 15 is provided in the sealed container 13 in which the long-fiber feeder 6 is arranged and that includes the depressurizer 14.

For example, an electric heater, an infrared heater, other convection or radiant heaters, or the like can be preferably used as the heater 15.

In the resin molded product manufacturing apparatus 1 according to the fourth modified example as described above, the long fiber heated by the heater 15 is fed into the heating tube 2. In the resin molded product manufacturing apparatus 1 according to the fourth modified example as described above, when the long fiber is added to the high-temperature molten resin composition (first mold material) conveyed from the first stage 21 (see FIG. 1), a temperature decrease of the molten resin composition is prevented. A heater for re-heating the mold material to a target temperature and maintaining the mold material at this temperature is thus unnecessary and it is possible to achieve stabilization of heating conditions for the mold material and size reduction of the resin molded product manufacturing apparatus 1.

According to the present disclosure, the manufacturing apparatus and method provide a resin molded product which has a higher stiffness and a higher strength than a conventional one.

What is claimed is:

1. A manufacturing apparatus for a molded product of a fiber-reinforced resin,
the manufacturing apparatus comprising:
a heating tube;
a screw inserted in the heating tube;
an injector provided on a front end side of the screw;
a resin feeder configured to feed a matrix resin into the heating tube;
a long-fiber feeder configured to feed a long fiber into the heating tube; and
a short-fiber feeder configured to feed a short fiber shorter than the long fiber into the heating tube,
wherein the short-fiber feeder is closer to a rear end of the screw than the long-fiber feeder is.

2. The manufacturing apparatus according to claim 1,
wherein the heating tube has a common feed port for the resin feeder and the short-fiber feeder.

3. The manufacturing apparatus according to claim 2, further comprising: a mixer configured to mix the matrix resin and the short fiber in advance before the matrix resin and the short fiber are fed into the heating tube.

4. The manufacturing apparatus according to claim 1,
wherein the heating tube has feed ports for the long fiber which are arranged circumferentially on the heating tube.

5. The manufacturing apparatus according to claim 1,
wherein the long-fiber feeder is included in a sealed container including a depressurizer.

6. The manufacturing apparatus according to claim 1, further comprising: a heater configured to heat the long fiber in advance before the long fiber is fed into the heating tube.

7. The manufacturing apparatus according to claim 1,
wherein the heating tube includes a lid provided on the feeding port for the long fiber, and
wherein the lid has through holes through which the long fiber of a unbroken fiber is inserted.

8. The manufacturing method for a molded product of a fiber-reinforced resin, the manufacturing method comprising:
forming a mold material by feeding a matrix resin, a long fiber, and a short fiber shorter than the long fiber into a heating tube including a screw therein; and
injecting the mold material from the heating tube into a mold,
wherein the long fiber is fed into the heating tube downstream of positions at which the matrix resin and the short fiber are fed respectively.
